(19) United States
(12) Patent Application Publication
(10) Pub. No.: US 2015/0324136 A1
(43) Pub. Date: Nov. 12, 2015

(54) STORAGE SYSTEM HAVING FIFO STORAGE AND RESERVED STORAGE

(71) Applicant: LSI Corporation, San Jose, CA (US)

(72) Inventors: Xiangdong Guo, Shanghai (CN); Zhibin Li, Shanghai (CN); Zhiwei Wu, Shanghai (CN); Rui Shen, Shanghai (CN)

(73) Assignee: LSI Corporation, San Jose, CA (US)

(21) Appl. No.: 14/271,588

(22) Filed: May 7, 2014

(51) Int. Cl. G06F 3/06

(52) U.S. Cl. CPC G06F 3/0619; G06F 3/0689; G06F 3/0665; G06F 2003/0692

(57) ABSTRACT

An apparatus having first-in-first-out storage and reserved storage is disclosed. In one or more embodiments, the apparatus includes memory circuitry having first-in-first-out storage and reserved storage. The first-in-first-out storage and the reserved storage include an array of data elements having contiguous addresses across the first-in-first-out storage and the reserved storage. The memory circuitry includes a first-in-first-out pointer for referencing an index corresponding to a data element of the array of data elements of the first-in-first-out storage to be read and a read pointer mapped to the first-in-first-out pointer and for referencing a memory location of the data element to be read. The read pointer is mapped such that the read pointer does not reference a plurality of data elements stored in the reserved storage.

### FIELD OF THE INVENTION

The present disclosure is directed to an apparatus including first-in-first-out (FIFO) storage and reserved storage, and more particularly to an apparatus including first-in-first-out (FIFO) storage and reserved storage having a read pointer mapped such that the read pointer does not reference data elements stored in the reserved storage.

### BACKGROUND

Buffers are memory circuits that may be used to temporarily store information in electronic data processing systems, for example to change the format or length of data produced by one component so that it can be used by the next in the data processing system. One such buffer is a synchronous barrel shift buffer that may be used in a magnetic hard disk drive. The barrel shift buffer temporarily stores data between encoders as a data sector is prepared for writing to the disk, adapting a variable length output from a first encoder to a fixed length input to a second encoder.

### SUMMARY

An apparatus having first-in-first-out storage and reserved storage is disclosed. In one or more embodiments, the apparatus includes memory circuitry having first-in-first-out storage and reserved storage. The first-in-first-out storage and the reserved storage include an array of data elements having contiguous addresses across the first-in-first-out storage and the reserved storage. The memory circuitry includes a first-in-first-out pointer for referencing an index corresponding to a data element of the array of data elements of the first-in-first-out storage to be read and a read pointer mapped to the first-in-first-out pointer and for referencing a memory location of the data element to be read. The read pointer is mapped such that the read pointer does not reference a plurality of data elements stored in the reserved storage.

This Summary is provided to introduce a selection of concepts in a simplified form that are further described below in the Written Description. This Summary is not intended to identify key features or essential features of the claimed subject matter, nor is it intended to be used as an aid in determining the scope of the claimed subject matter.

### BRIEF DESCRIPTION OF THE FIGURES

The Written Description is described with reference to the accompanying figures. The use of the same reference numbers in different instances in the description and the figures may indicate similar or identical items.

FIG. 1 is a block diagram of a storage system including a FIFO in accordance with an example embodiment of the present disclosure.

FIG. 2 is a block diagram of a storage system including a storage device in accordance with an example embodiment of the present disclosure.

FIG. 3 is a block diagram of the storage system including a storage device including FIFO storage and reserved storage in accordance with an example embodiment of the present disclosure.

FIG. 4 is a method diagram for mapping a read pointer to a FIFO pointer in accordance with an example embodiment of the present disclosure.

### WRITTEN DESCRIPTION

Variable-length data blocks to be written in a first-in-first-out (FIFO) storage can be normalized to the maximum expected or allowable length. Data can be aligned to the most significant bit (MSB) in the input block with zero-padding added as needed at the least significant bit (LSB) end of the input block to achieve input blocks with uniform length. A word write pointer tracks the next row in the FIFO with free space, and a bit write pointer tracks the next available bit position in the row identified by the word write pointer. As a data block is written, empty bits in the last empty or partially empty row indicated by the word write pointer are filled in the FIFO. A width indicator signal provided with the data block indicates the number of data bits in the data block, excluding any zero padding at the LSB. The number of bits written to the FIFO is controlled by the width indicator signal. If the width indicator signal indicates that the data block is wider than the FIFO row, the data block is written across multiple FIFO rows or addresses automatically. When a data block has been written to the FIFO, the bit write pointer and word write pointer identify the next free bit position in the FIFO by column and row, respectively.

As discussed in greater detail below, a read pointer identifies the address of the next available FIFO row. During a read operation, the word at the address in the read pointer is output, and the read pointer is incremented.

By normalizing the length of input data blocks, a data block with a variable number of data bits up to a maximum width can easily be stored, filling in empty bit positions in partially filled rows. This allows combinational control logic to be placed on the write side of the FIFO, increasing logic sharing so that the overall size of the FIFO is reduced, and greatly simplifying read operations. The size of the multi-write bit-fill FIFO, and the ratio of combinational logic to sequential logic in the multi-write bit-fill FIFO, are substantially lower than in a conventional barrel shift buffer.

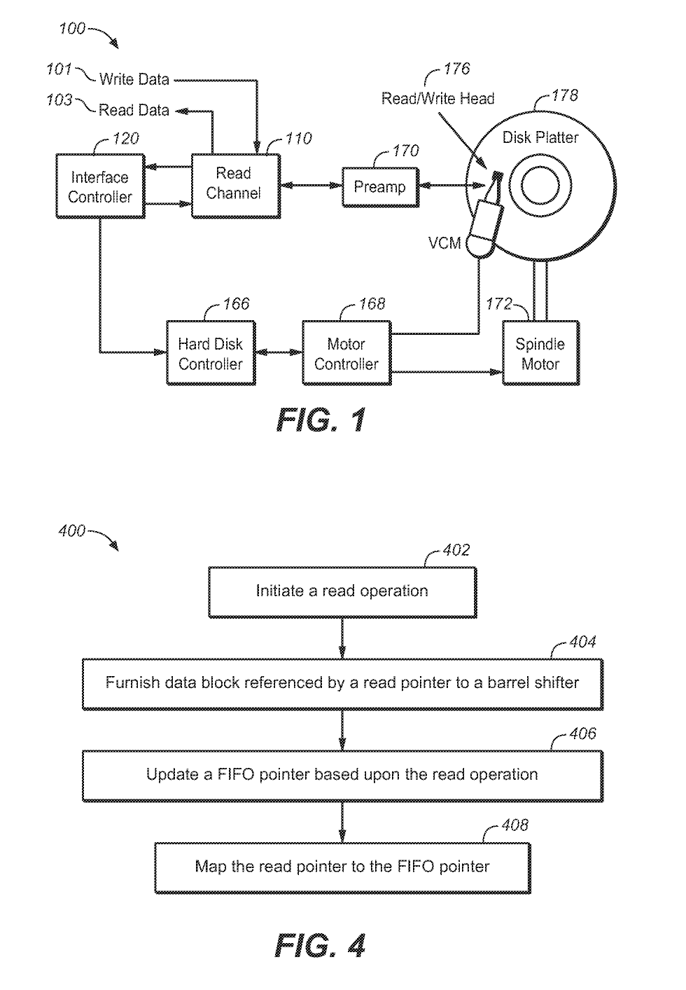

In FIG. 1 a system 100 is illustrated that includes a read channel circuit 110 including a first-in-first-out structure for data width conversion and auto zero padding in accordance with an example implementation of the present disclosure. The system 100 may be, for example, a hard disk drive (HDD). As shown, the system 100 includes a preamplifier 170, an interface controller 120, a hard disk controller 166, a motor controller 168, a spindle motor 172, a disk platter 178, and a read/write head assembly 176. The interface controller 120 controls addressing and timing of data to/from the disk platter 178. The data on the disk platter 178 includes groups of magnetic signals that may be detected by the read/write head assembly 176 when the assembly is properly positioned over disk platter 178. In one or more implementations, the disk platter 178 includes magnetic signals recorded in accordance with either a longitudinal or a perpendicular recording scheme.

In a typical read operation, the read/write head assembly 176 is accurately positioned by the motor controller 168 over a desired data track on the disk platter 178. The motor controller 168 positions the read/write head assembly 176 in relation to the disk platter 178 and drives the spindle motor 172 by moving the read/write head assembly 176 to the proper data track on the disk platter 178 under the direction of the hard disk controller 166. The spindle motor 172 spins the disk platter 178 at a determined spin rate (e.g., at a determined number of revolutions per minute (RPM)). Once the read/write head assembly 176 is positioned adjacent to the proper data track, magnetic signals representing data on the disk platter 178 are sensed by the read/write head assembly 176 as the disk platter 178 is rotated by the spindle motor 172. The sensed magnetic signals are provided as a continuous, minute analog signal representative of the magnetic data on the disk platter 178. This minute analog signal is transferred from the read/write head assembly 176 to the read channel circuit 110 via a preamplifier 170. The preamplifier 170 is operable to amplify the minute analog signals accessed from the disk platter 178. In turn, the read channel circuit 110 decodes and digitizes the received analog signal to recreate the information originally written to the disk platter 178. This data is provided as read data 103 to a receiving circuit. A write operation is substantially the opposite of the preceding read operation with write data 101 being provided to the read channel circuit 110. This data is then encoded and written to the disk platter 178.

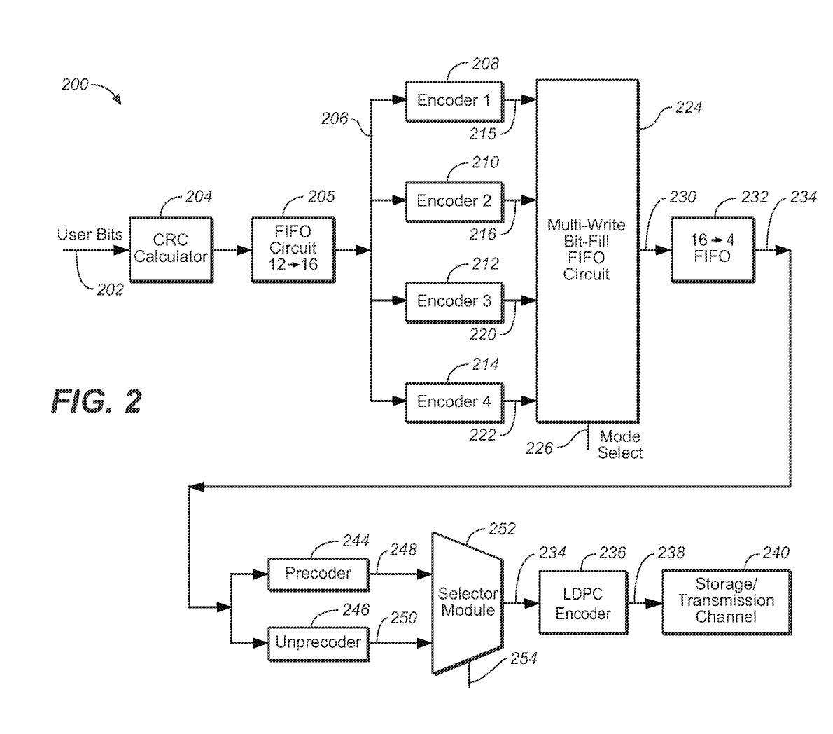

FIG. 2 illustrates a read channel 200 that can be used to store and retrieve or transmit and receive data in accordance with some embodiments of the present disclosure and includes a storage device (e.g., memory circuitry) 224. The read channel 200 is used to process digital user data bits 202, store them in or transmit them through a storage or transmission channel 240 and retrieve the user data bits 290 without introducing errors. The user data bits 202 may be processed in a cyclic redundancy check (CRC) calculator 204 that adds error-detection check values to blocks of data bits 202, providing a technique to detect errors introduced in the data bits in the read channel 200. The resulting codewords 206 from the CRC calculator 204 are provided to a first FIFO structure 205 to transition the codewords 206 from a first size to a second size (e.g., from a twelve (12) bit data block size) to a sixteen (16) bit data block size). The codewords 206 are then encoded in one or more data encoders 208, 210, 212, 214 to yield encoded data 215, 216, 220, 222. The data encoders 208, 210, 212, 214 may be an encoder with multiple operating modes or multiple separate selectable data encoders, with one encoder or operating mode being enabled to generate an output data stream. For example, a data encoder 208, 210, 212, 214 may be a run length limit (RLL) encoder. The frequency response of the read channel 200 is generally at a maximum at DC and degrades near the Nyquist frequency, particularly when the storage or transmission channel 240 is a magnetic storage device. By limiting the maximum transition run length in the encoded user bits (e.g., encoded data 215, 216, 220, 222), the read channel 200 operates below the Nyquist frequency and avoids errors that might be introduced by the degraded frequency response near the Nyquist frequency.

The encoded data 215, 216, 220, 222 from data encoders 208, 210, 212, 214 has variable length data blocks, depending on the encoding algorithm applied and other factors such as whether the data block is at the end of a data sector, limiting the number of data bits in the block. One of the streams of encoded data 215, 216, 220, 222 are encoded again, for example in a low density parity check (LDPC) encoder 236, which calculates and adds parity bits to the data. In this example, LDPC encoder 236 requires that data be input in O-bit blocks. A storage device 224, as disclosed herein, is used to buffer and convert the variable-length data blocks in the encoded data 215, 216, 220, 222 from data encoders 208, 210, 212, 214 to 16-bit blocks, which are further divided in 16→4 FIFO 232 for the LDPC encoder 236. In other embodiments, the storage device 224 may be adapted to yield 4-bit blocks directly for the LDPC encoder 236, or any other width data blocks as desired. The multi-write bit-fill FIFO 224 thus receives an input data stream with variable length blocks at one of encoded data signals 215, 216, 220, 222, and outputs fixed width data blocks at output 230. The standard input data block width may be selected with mode select input 226, although the input data blocks may have any width from zero (0) up to the selected width if the block is at the end of a data sector. The output 230 is provided to 16→4 FIFO 232, which yields 4-bit data blocks 234 for the LDPC encoder 236. As shown in FIG. 2, in some embodiments, the 4-bit data blocks 234 are provided to a precoder 244 and an unprecoder 246. The precoder 244 can perform a (1+D) function on the data and provide support for the modulation code applied in non-return-to-zero (NRZ) code and/or non-return-to-zero inverse code. The precoder 244 and the unprecoder 246 output respective data blocks 248, 250 to a selector module 252. A selector module 252 utilizes a select signal 254 to select which data block 248, 250 to output to the LDPC encoder 236.

The LDPC encoder 236 produces and multiplexes in parity bits, yielding an encoded data stream 238 that may be further processed or manipulated before storage or transmission in storage or transmission channel. For example, the encoded data stream 236 may be converted to analog format and modulated or otherwise processed before it used to drive a magnetic write head or to be transmitted as a radio frequency signal or other wired or wireless signal.

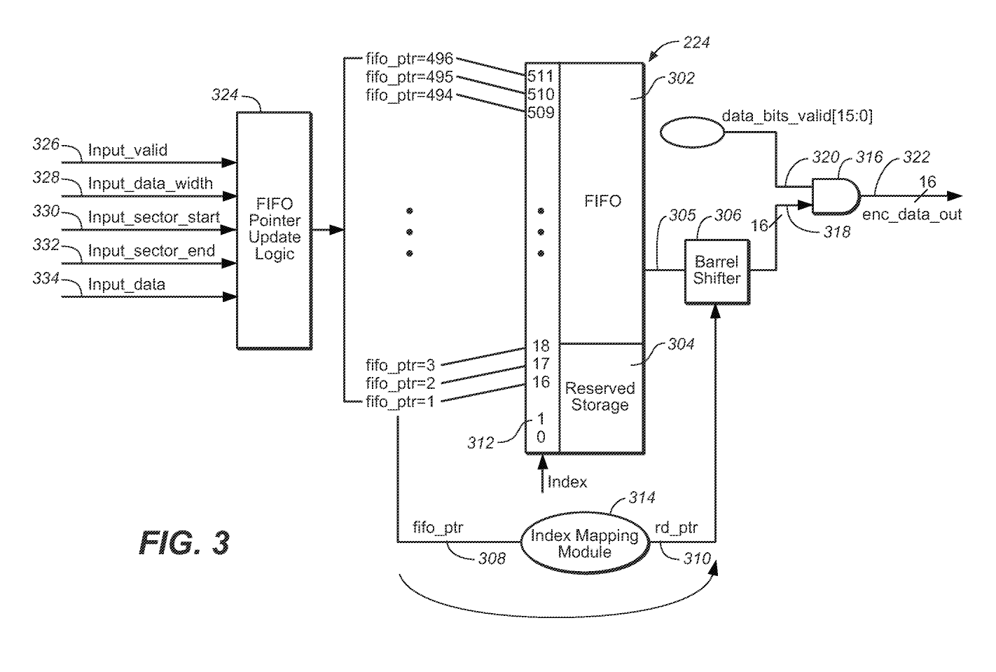

As shown in FIG. 3, the storage device 224 (e.g., a memory circuit) includes a FIFO storage 302 and a reserved storage 304 includes an array of data elements (e.g., data). For example, the storage device 224 comprises integrated circuitry for storing data blocks. The storage device 224 may be utilized within storage devices, such as redundant array of independent disks (RAIDs). In an embodiment of the present disclosure, the storage device 224 is sixteen (16) bits wide and thirty-two (32) rows deep, for a five hundred and twelve (512) bit capacity. In some embodiments, the reserved storage 304 comprises sixteen (16) rows of data. The data is read from the storage device 224 via an output data bus 305. As shown, the array of data elements comprise continuous addresses (e.g., memory addresses) across the FIFO storage 302 and the reserved storage 304. In some embodiments, the output data bus 305 comprises a sixteen (16) bit output data bus. As shown, the data bus 305 is communicatively connected to a barrel shifter 306, and the barrel shifter 306 is configured to temporarily store data as a data sector for writing to the disk platter 178.

In one or more embodiments, the system 100 includes a FIFO pointer (fifo_ptr) 308 and a read pointer (rd_ptr) 310. In an embodiment, the FIFO pointer 308 maintains a value representing how many valid bits are remaining within storage device 224, and the read pointer 310 maintains a value representing the next read bit position in a current row of the storage device 224 (e.g., indicates the start position to read next data from the storage device 224). For example, the read pointer 310 identifies a row address of a next row to be read from the storage device 224. In an embodiment, the FIFO pointer 308 references an index (shown as index 312 in FIG. 3). The index 310 represents memory addresses that correspond to a respective row of data elements within the storage device 224. For example, the index value “0” references the first row of data within the storage device 224, and the index value “511” references the last row of data within the storage device 224. For each read operation, in an example embodiment, a sixteen (16) bit data block at the location specified by the read pointer 310 is shifted (e.g., shifted out to the barrel shifter 306 as described below), and the value of the read pointer 310 is transitioned (e.g., read pointer value is incremented) by sixteen (16) bits to the next location.

As shown in FIG. 3, the system 100 also includes an index mapping module 314, which represents functionality for generating the read pointer 310 based upon the FIFO pointer 308. For example, the index mapping module 314 generates (e.g., maps) a read pointer 310 based upon the value of the FIFO pointer 308 such that the read pointer 310 does not reference an address corresponding to the reserved storage 304. In the above described embodiment, the index mapping module 314 logic comprises rd_ptr=(fifo_ptr−1)+16. As shown in FIG. 3, the index mapping module 314 provides the read pointer 310 to the barrel shifter 306, and the barrel shifter 306 performs a read operation to read a data word from the FIFO storage 302 corresponding to the read pointer 310 value (e.g., reads a data word at the location within the FIFO storage 302 referenced by the read pointer 310. The data word may be a data word (e.g., a data block) of a fixed-width (e.g., a 16-bit data block). In some embodiments, the system 100 includes a single barrel shifter 306. Table 1 illustrates example pseudo code in accordance with the present disclosure.

TABLE 1

rd_ptr = fifo_ptr +15;
valid_bits_num = (out_cnt >=16) ? 5′b10000 :out_cnt[4:0];
data_out = buffer[rd_ptr -:16] & data_bits_valid;
casez ({valid_bits_num[4:0]})
5′b10000 :data_bits_valid =16′hffff;
5′b01111 :data_bits_valid =16′hfffe;
5′b01110 :data_bits_valid =16′hfffc;
5′b01101 :data_bits_valid =16′hfff8;
5′b01100 :data_bits_valid =16′hfff0;
5′b01011 :data_bits_valid =16′hffe0;
5′b01010 :data_bits_valid =16′hffc0;
5′b01001 :data_bits_valid =16′hff80;
5′b01000 :data_bits_valid =16′hff00;
5′b00111 :data_bits_valid =16′hfe00;
5′b00110 :data_bits_valid =16′hfc00;
5′b00101 :data_bits_valid =16′hf800;
5′b00100 :data_bits_valid =16′hf000;
5′b00011 :data_bits_valid =16′he000;
5′b00010 :data_bits_valid =16′hc000;
5′b00001 :data_bits_valid =16′h8000;
default :data_bits_valid = 16′d0;
endcase

As shown in FIG. 3, the barrel shifter 306 outputs the data word to a comparison module 316 at input 318, and the comparison module 324 compares the received data word to a valid data word (at input 320) and outputs an encoded data word at output 322. For example, a valid bits signal (e.g., a valid_bits_num) indicates how much valid data is to be read in next read operation. An internal counter (out_cnt) can be set to a predetermined sector size at the beginning of each sector and decreased for each read operation (e.g., decreased by 16). If the internal counter is equal to or less than a predefined threshold (e.g., 16), the internal counter is reset to the sector bit size after the final read operation. In an embodiment, the comparison module 316 comprises an AND module that provides AND logic functionality.

The system 100 includes a FIFO pointer update module 324 that provides functionality for updating the FIFO pointer 308 based upon a read operation and/or a write operation. For example, the FIFO pointer update module 324 can receive an input valid signal 326 (e.g., a signal representing when a new encoded data word is ready, which indicates that valid data is to be written to the FIFO storage 302, and the write pointer is to be updated as the data in the FIFO storage 302 is changed), an input data width signal 328, an input sector start signal 330, an input sector end signal 332, and an input data signal 334. For example, once a read operation and/or a write operation has initiated, the FIFO pointer update module 324 updates the FIFO pointer 308 to the address that is to be read next after the read/write operation has completed. In some embodiments, the system 100 includes zero-padding circuitry that is configured to set extra least significant bits to zero. For example, the system 100 may incorporate zero padding circuitry in accordance with the subject matter discloses in U.S. Patent Application No. 2014/0019650, entitled MULTI-WRITE BIT-FILL FIFO, which is hereby incorporated herein by reference. For example, the data encoders 208, 210, 212, 214 may include zero padding circuitry for setting the least significant bits to zero to allow for uniform output data widths.

The system 100 can allow for a valid fetch of a data block from the storage device 224 (e.g., in the event there is one (1) valid data block in the storage device 224). In some embodiments, a single barrel shifter 306 is utilized to read data from the storage device 224, which reduces the amount of area (in comparison to storage systems utilizing up to an additional fifteen (15) barrel shifters).

FIG. 4 illustrates a method 400 for performing a read operation from a storage device in accordance with the present disclosure. As shown, a read operation is initiated (Block 402). In one or more embodiments, the system 100 receives a command to initiate a read operation. A data block referenced by the read pointer is furnished to a barrel shifter (e.g., shifted out to the barrel shifter) (Block 404). In an embodiment, a sixteen (16) bit data word referenced by the read pointer 310 is provided to the barrel shifter 306. A FIFO pointer is updated based upon the read operation (Block 406). One or more data signals to update the FIFO pointer 308 are provided to the FIFO pointer update module 332. The FIFO pointer update module 332 updates the FIFO pointer 308 based upon the received data signals such that the FIFO pointer 308 references a respective index pertaining to the next data block to be read. The read pointer is mapped to the FIFO pointer (Block 408). As described above, an index mapping module 314 provides logic to map the read pointer 310 to FIFO pointer 308 such that a data block within the reserved storage 304 is not provided to the barrel shifter when a read operation is performed.

Generally, any of the functions described herein can be implemented using hardware (e.g., fixed logic circuitry such as integrated circuits), software, firmware, manual processing, or a combination of these embodiments. Thus, the blocks discussed in the above disclosure generally represent hardware (e.g., fixed logic circuitry such as integrated circuits), software, firmware, or a combination thereof. In the instance of a hardware embodiment, for instance, the various blocks discussed in the above disclosure may be implemented as integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software embodiment, for instance, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
memory circuitry having first-in-first-out storage and reserved storage, the first-in-first-out storage and the reserved storage including an array of data elements having contiguous addresses across the first-in-first-out storage and the reserved storage, the memory circuitry including a first-in-first-out pointer configured to reference an index corresponding to at least one data element of the array of data elements of the first-in-first-out storage to be read, the memory circuitry including a read pointer mapped to the first-in-first-out pointer and configured to reference a memory location of the data element to be read,
wherein the read pointer is mapped such that the read pointer does not reference a plurality of data elements stored in the reserved storage.

2. The apparatus as recited in claim 1, further comprising a barrel shifter communicatively connected to the memory circuitry for receiving a data block from the first-in-first-out storage during a read operation.

3. The apparatus as recited in claim 1, wherein the read pointer identifies a row address of a next row to be read from the memory circuitry.

4. The apparatus as recited in claim 1, wherein the data element to be read stores a data block.

5. The apparatus as recited in claim 4, wherein the data block comprises a data block of a fixed-width.

6. The apparatus as recited in claim 1, wherein the memory circuitry is implemented as an integrated circuit.

7. The apparatus as recited in claim 1, wherein the memory circuitry is incorporated in a storage device.

8. The apparatus as recited in claim 7, wherein the storage device comprises a redundant array of independent disks.

9. A system comprising:
memory circuitry having first-in-first-out storage and reserved storage, the first-in-first-out storage and the reserved storage including an array of data elements having contiguous addresses across the first-in-first-out storage and the reserved storage, the memory circuitry including a first-in-first-out pointer configured to reference an index corresponding to at least one data element of the array of data elements of the first-in-first-out storage to be read; and
an index updating module configured to receive the first-in-first-out pointer and generate a read pointer, the read pointer mapped to the first-in-first-out pointer and configured to reference a memory location of the data element to be read, wherein the read pointer is mapped such that the read pointer does not reference a plurality of data elements stored in the reserved storage.

10. The system as recited in claim 9, further comprising a barrel shifter communicatively connected to the memory circuitry for receiving a data block from the first-in-first-out storage during a read operation.

11. The system as recited in claim 9, wherein the read pointer identifies a row address of a next row to be read from the memory circuitry.

12. The system as recited in claim 9, wherein the data element to be read stores a data block.

13. The system as recited in claim 12, wherein the data block comprises a data block of a fixed-width.

14. The system as recited in claim 9, wherein the memory circuitry is implemented as an integrated circuit.

15. The system as recited in claim 9, wherein the memory circuitry is incorporated in a storage device.

16. The system as recited in claim 15, wherein the storage device comprises a redundant array of independent disks.

17. A method comprising:
receiving a command to initiate a read operation at a storage device, the storage device including first-in-first-out storage and reserved storage, the first-in-first-out storage and the reserved storage including an array of data elements having contiguous addresses across the first-in-first-out storage and the reserved storage, the array of data elements for storing data blocks;
furnishing a data block referenced by a read pointer to a barrel shifter, the data block stored in the first-in-first-out storage;
updating a first-in-first-out pointer based upon the read operation, the first-in-first-out pointer for referencing an index corresponding to at least one data element of the array of data elements of the first-in-first-out storage to be read; and
mapping a read pointer to the first-in-first-out pointer such that the read pointer does not reference a plurality of data elements stored in the reserved storage.

18. The method as recited in claim 17, wherein the read pointer identifies a row address of a next row to be read from the memory circuitry.

19. The method as recited in claim 17, wherein the data element to be read stores a data block.

20. The method as recited in claim 19, wherein the data block comprises a data block of a fixed-width.
